(19) United States
(12) Patent Application Publication
(10) Pub. No.: US 2005/0213631 A1
(43) Pub. Date: Sep. 29, 2005

(54) Solid state laser

(76) Inventor: Hans Amler, Lauf an der Pegnitz (DE)

Correspondence Address: DAFFER MCDANEIL LLP, P.O. BOX 684908, AUSTIN, TX, 78768, US

(21) Appl. No.: 11/079,460

(22) Filed: Mar. 12, 2005

(30) Foreign Application Priority Data
Mar. 11, 2004 (DE) 10 2004 012 307.1

(51) Int. Cl. H01S 3/091; H01S 3/092; H01S 3/094

(52) U.S. Cl. 372/70; 372/75

(57) ABSTRACT

A solid state laser with a rod-shaped laser-active medium is pumped by at least one pumped light source having a plurality of laser diodes, and is provided with at least partially reflecting surfaces forming a resonator. By means of a highly reflecting coating on one side of the laser-active medium, and also by means of further reflectors, the light from the pumped light source is repeatedly reflected into the laser-active medium along the axis of the resonator.

### BACKGROUND OF THE INVENTION

1. Field of the Invention

The invention relates to a solid state laser preferably pumped with diodes.

2. Description of the Prior Art

A variety of designs of solid state lasers are known from prior art. Thus, EP-A-0 632 551 discloses a solid state laser in which the laser-active medium is disposed in the shape of a cylindrical disc on a reflectively coated cooling block. In order to achieve a high efficiency of coupling-in the pumped light, it is passed repeatedly through the laser-active medium by reflection at a reflectively coated cooling block and at additional mirrors. An advantage of the arrangement is good heat conduction owing to a large area of the laser-active medium being supported on the cooling block. A substantial disadvantage of this arrangement is the large mechanical outlay. Thus, for an embodiment cited as an example, each one of 4 pumping mirrors must be adjustable along three axes in space. In addition to this, a multiplicity of different attachment and adjusting elements are needed. Furthermore, with this arrangement pumped light of a circular beam cross-section must be coupled in. However, it is difficult to achieve a circular beam cross-section of this kind with an arrangement comprising a multitude of laser diodes. A further disadvantage of this arrangement is the relatively large cross-section of the beam.

A solid state laser enabling better pumping with laser diodes is disclosed in U.S. Pat. No. 6,167,069 A, for example. With this, the laser-active medium is of rod-shaped design (slab), for example an Er:YAG crystal bonded onto an optically transparent support. The light generated by a laser diode arrangement is supplied to the laser-active medium via a lens through an optically transparent support. With this arrangement, it is of disadvantage that the efficiency of coupling-in the pumped light is relatively small, because only one passage of the pumped light through the laser-active medium is possible.

An improvement of the efficiency is made possible by the design disclosed in U.S. Pat. No. 6,014,391 A. Here a multiple passage of the pumping light through the laser-active medium is effected. Of disadvantage with this arrangement is the irregular intensity distribution of the generated laser beam. In order to compensate this at least partly, a complicated shape of the laser-active medium is necessary.

### BRIEF SUMMARY OF THE INVENTION

The invention is based on the object of designing a solid state laser or slab laser, and a method for pumping a solid state or slab laser, which make possible an achievement of a high power density within a laser-active medium at low expenditure of material of the laser-active medium and simultaneously with a high efficiency of coupling-in pumped light.

In accordance with the invention, the above object is achieved with a solid state laser or slab laser, comprising a laser-active medium (slab); a highly reflecting layer on one side of the laser-active medium; at least one pumped light source comprising at least one laser diode; and a resonator formed by at least partially reflecting surfaces; wherein light from the at least one pumped light source is coupled into the laser-active medium so that it is reflected by the highly reflecting layer after passing through the laser-active medium; and at least one first added reflector is provided for reflecting light from the pumped light source back into the laser-active medium through a site along an axis of the resonator displaced from a site of a previous reflection.

In accordance with the invention, the above object is also achieved with a solid state laser comprising: a laser-active medium (slab); at least one pumped light source comprising at least one laser diode; and a resonator formed by at least partially reflecting surfaces; wherein the laser-active medium comprises a doping profile that extends along a direction of the resonator, and occupies only a part of the cross-section of the laser-active medium, and is of a cross-section that is substantially square, circular, or elliptical.

Within the scope of the above object, the invention also provides a laser-active medium for a solid state laser that comprises: a laser-active medium (slab); at least one pumped light source that comprises at least one laser diode; and a resonator formed by at least partially reflecting surfaces; wherein the laser-active medium comprises a doping profile extending along a direction of the resonator and having a cross-section that is substantially circular, elliptical or substantially square.

In accordance with the invention, the above object is also achieved with a method for pumping a solid state laser or slab laser provided with a laser-active medium (slab), a highly reflecting layer on one side of the laser-active medium, a resonator defined by at least partially reflecting surfaces, and a pumped light source; the method comprising the steps of: generating pumped light with the pumped light source; coupling the pumped light into the laser-active medium through a first entry site on the laser-active medium, and reflecting pumped light that has performed a first passage through the laser-active medium with the highly reflecting layer to perform a second passage through the laser-active medium; and using a first added reflector to reflect pumped light that has performed the second passage through the laser-active medium back into the laser-active medium through a second entry site on the laser-active medium to perform a third passage through the laser-active medium, the second entry site being displaced at least partially with respect to the first entry site along a direction of an axis of the resonator.

### DETAILED DESCRIPTION OF THE INVENTION

A solid state laser in accordance with the invention comprises at least one preferably rod-shaped or plate-shaped laser-active medium. A laser-active medium of this kind is frequently also referred to as a “slab”. It is preferably mounted on a cooling block, but may also be directly immersed in a flow of a cooling medium. Furthermore, at least one pumped light source is provided that preferably comprises a plurality of laser diodes. It is of particular advantage for this arrangement to be a linear stack of laser diodes. This is preferably fabricated from a monolithic semiconductor. Furthermore, at least partially reflecting and opposing surfaces are provided to form a resonator. In the following, the optical axis along which the radiation is reflected between the opposite surfaces is termed as being the axis of the resonator. The surfaces of the resonator may be formed, for example, in accordance with prior art by reflectively coating faces of the laser-active medium. Alternatively, the reflection at a boundary surface between optical media having different refractive indices may be used. Similarly, these reflective surfaces may also be discrete mirrors. Normally one of these reflecting surfaces is designed to be a highly reflecting surface (HR), whilst the surface opposite to this is partially transparent to permit the passage of light being coupled out. For operation it is important for the laser-active medium to be located at least partly between the two at least partially reflecting opposite surfaces, i.e. on the axis of the resonator.

Furthermore, according to the invention a highly reflecting layer or coating is provided on one side (surface) of the laser-active medium. If the laser-active medium is mounted on a cooling block, then a highly reflecting layer or coating is provided between the laser-active medium and the cooling block. A pumped light source preferably comprising a plurality of laser diodes generates pumped light that is coupled into the laser-active medium so that it is reflected by the highly reflecting layer and again passes through the laser-active medium. Furthermore, at least one added reflector is provided for reflecting the reflected light back again into the laser-active medium. For this it is important for the site of coupling-in into the laser-active medium to be at least partly different from the site of the first coupling-in, an at least partial overlap being permissible. However, the sites of coupling-in are chosen so that they lie along the axis of the resonator.

Now, although devices which enable multiple passages of the pumped light through the laser-active medium are known in prior art, the substantial difference from prior art resides in that these passages, according to the design, pass either through an identical volume, as in EP-A 0 632 551, which leads to a very large beam cross-section, or perpendicularly to the resonator, as in U.S. Pat. No. 6,014,391 A, which results in a non-uniform density of the intensity of the generated laser beam. All this is avoided with multiple passages in accordance with the invention, which pass in the direction of the resonator.

Of course, according to the inventive concept the laser-active medium, instead of being a solid body, may also be a liquid which is contained in an optical cell, for example.

In a further embodiment of the invention the light of at least one pumped light source is coupled into the laser-active medium obliquely at a given angle. This angle is preferably at about 45 degrees to the axis of the resonator.

Another embodiment of the invention provides a further reflector for reflecting the light of the pumped light source back into the laser-active medium at the site of the previous reflection. If this reflection into the laser-active medium occurs at the same angle of incidence as the preceding angle of emergence, then the light is also reflected back in the direction of the pump light source via further reflectors along the previous light path. With this, plural passages of the pumped light through the reflector arrangement may be achieved. For this, similarly, polarization-rotating or polarization-selective elements according to prior art may be utilized.

In another advantageous embodiment of the invention, at least one laser-active medium is provided with a doping that extends along the direction of the resonator, i.e. in the direction of the axis between the two at least partially reflecting opposite surfaces. Furthermore, the doped region should be between the two surfaces. In the present document the term “doped region” is understood to mean a region of relatively high doping of the laser material with the laser-active ion, such as of an order of magnitude of 0.5 to 2% by volume. A non-doped region differs from the doped region by the doping being substantially less, preferably by at least one order of magnitude.

Furthermore, the doping is restricted to only one part of a cross-section of the laser-active medium perpendicular to the axis of the resonator.

In a particularly advantageous embodiment of the invention, the laser-active medium is provided with a doping profile built up of layers. The layers extend preferably parallel to the highly reflecting layer.

In another advantageous embodiment of the invention the laser-active material is provided with a doping profile built up of layers, the layers extending preferably perpendicular to the highly reflecting layer.

Another advantageous embodiment of the invention provides that a non-doped layer be first disposed to be parallel to the highly reflecting layer. On top of this layer, and covering a part of the width of this first layer, a doped second layer having a thickness of preferably 0.5 to 2 mm is coated. Finally and optionally, a non-doped covering layer may be coated onto the entire arrangement.

In another advantageous embodiment of the invention, the doping profile of the laser-active medium is designed to have a circular or elliptical cross-section. Similarly, the cross-section may also be rectangular, preferably substantially square. In this, the diameter or a side length is preferably between 0.5 and 2 mm. Similarly and optionally, the cross-section of the doping profile may also be freely chosen to be of any other configuration.

Furthermore, the invention includes a laser-active medium for a solid state laser that comprises at least one pumped light source preferably having a plurality of laser diodes, and a resonator formed by at least partially reflecting surfaces. The laser-active medium according to the invention is preferably rod-shaped or plate-shaped and is provided with doping which extends along the direction of the resonator and is of circular or elliptical cross-section. Similarly, the cross-section may also be rectangular, preferably substantially square. In this, the diameter or side length is preferably between 0.5 and 2 mm.

### BRIEF DESCRIPTION OF THE DRAWINGS

In the following the invention will be described by way of example, without limitation of the inventive concept, on examples of embodiment and with reference to the drawings.

FIG. 1 shows a cross-section along the resonator axis of an example of a device according to the invention.

FIG. 2 shows an example of another embodiment of the device according to the invention.

FIG. 3 shows a cross-section across the resonator axis of an example of another device according to the invention.

### DESCRIPTION OF PREFERRED EMBODIMENTS

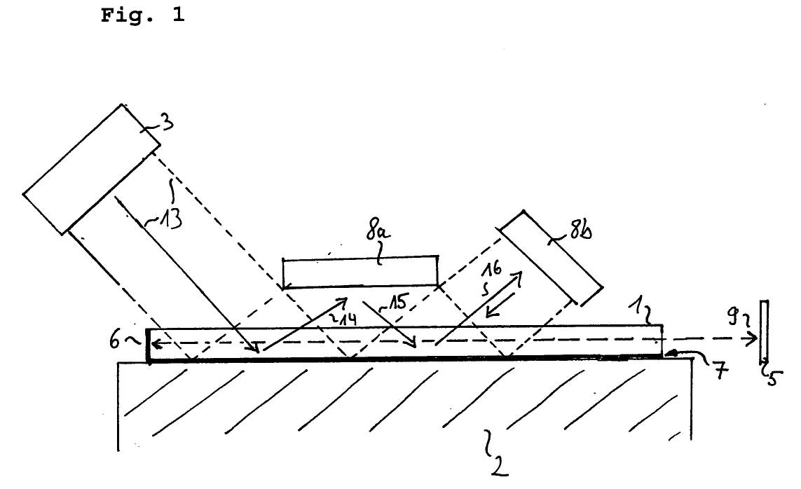

In FIG. 1 a cross-section through an example of a solid state laser in accordance with the invention is shown.

A laser-active medium 1, preferably designed in the form of a rod or a plate, has a highly reflecting layer 7 on one side. The laser-active medium may be mounted on a cooling block 2, as here illustrated. Similarly, it may also be supported at its ends and directly immersed in a flow of a cooling medium. Of importance to the invention is the highly reflecting layer. Optionally this highly reflecting layer may be directly deposited onto the laser-active medium (a coating). However, it may also be deposited on a support, such as for example a cooling block or another plate. To form a resonator 9, a first mirror 5, and a second mirror 6 that in this example may be directly deposited onto the laser-active medium, are provided. Furthermore, the light of a pumped light source 3 may be coupled into the laser-active medium 1 (ray path 13) so that it is reflected by the highly reflective layer after passing through the medium. The reflected light again passes through the medium (ray path 14) and is reflected back into the medium (ray path 15) by a first mirror 8a. Following a new reflection at the highly reflecting layer, the light is reflected to the second mirror 8b (ray path 16). Now this mirror is designed so that the light is reflected back along the same path, so that it follows its path for a second time. With this arrangement, a particularly high efficiency of coupling-in of the pumped light may be achieved. Of course, further multiple passes may be achieved with further mirrors. Similarly, the light of a subsequent pass may be coupled-in to be slightly displaced with respect to that of a previous pass.

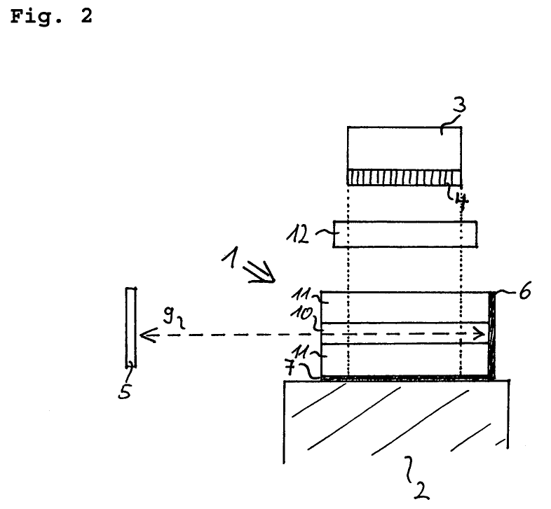

In FIG. 2 an example of another embodiment of a device according to the invention is shown. A solid state laser having a preferably rod-shaped or plate-shaped laser-active medium 1 and a first mirror and a second mirror which are here formed by way of example as a coating on the laser-active medium is pumped by a pumped light source 3. The pumped light source 3 has an array of laser-diodes 4. the light of which is coupled into the laser-active medium by means of a collimator 12. Furthermore, in this case of the invention, an optional highly reflecting coating 7 is provided in order to reflect the light of the pumped light source and thus to pass it at least once more through the laser-active medium. However, of importance with this embodiment of the invention is the design of a doped zone 10 within the non-doped zone 11.

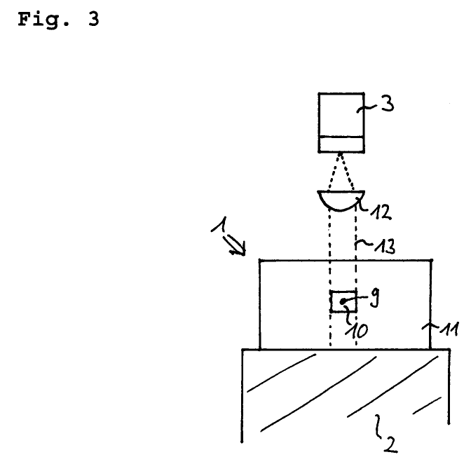

In FIG. 3 a cross-section perpendicular to the axis of the resonator 9 of the device of FIG. 2 is shown. Here an example of an almost square design of the doped zone 10 can be seen. Furthermore, the ray path 13 of the pumped light from the pumped light source 3 via the collimator 12 into the doped zone 10 is shown.

1-11. (canceled)

12. Solid state laser or slab laser, comprising:
a laser-active medium (slab);
a highly reflecting layer on one side of the laser-active medium;
at least one pumped light source comprising at least one laser diode;
a resonator formed by at least partially reflecting surfaces;
wherein light from the at least one pumped light source is coupled into the laser-active medium so that it is reflected by the highly reflecting layer after passing through the laser-active medium; and
at least one first added reflector is provided for reflecting light from the pumped light source back into the laser-active medium through a site along an axis of the resonator displaced from a site of a previous reflection.

13. Laser according to claim 12, wherein the laser-active medium is rod-shaped or plate-shaped.

14. Laser according to claim 12, wherein the pumped light source comprises a plurality of laser diodes.

15. Laser according to claim 12, wherein light from the at least one pumped light source is coupled into the laser-active medium obliquely at a given angle.

16. Laser according to claim 12, wherein at least one second added reflector is provided for reflecting light from the at least one pumped light source back into the laser-active medium at a site that is the same as a site of a previous reflection.

17. Laser according to claim 12, wherein the laser-active medium comprises a doping profile built-up of layers.

18. Laser according to claim 17, wherein the layers extend parallel to the highly reflecting layer.

19. Laser according to claim 17, wherein the layers extend perpendicularly to the highly reflecting layer.

20. Laser according to claim 17, wherein a non-doped layer is disposed to be parallel to the highly reflecting layer, and a doped layer is coated onto the non-doped layer.

21. Laser according to claim 20, wherein the doped layer has a thickness of 0.5 to 2 mm.

22. Laser according to claim 20, wherein a further non-doped layer is disposed on the doped layer.

23. Laser according to claim 12, wherein the laser-active medium comprises a doping profile having a cross-section substantially of the shape of a square with a side length of 0.5 mm to 2 mm.

24. Laser according to claim 12, wherein the laser-active medium comprises a doped profile having a cross-section of a substantially circular or elliptical shape with a diameter of 0.5 mm to 2 mm.

25. Solid state laser, comprising:
a laser-active medium (slab);
at least one pumped light source comprising at least one laser diode;
a resonator formed by at least partially reflecting surfaces; and
wherein the laser-active medium comprises a doping profile that extends along a direction of the resonator, and occupies only a part of the cross-section of the laser-active medium, and is of a cross-section that is substantially square, circular, or elliptical.

26. Laser according to claim 25, wherein the laser-active medium is rod-shaped or plate-shaped.

27. Laser according to claim 25, wherein the pumped light source comprises a plurality of laser diodes.

28. Laser-active medium for a solid state laser that comprises:
a laser-active medium (slab);
at least one pumped light source that comprises at least one laser diode;
a resonator formed by at least partially reflecting surfaces; and
wherein the laser-active medium comprises a doping profile extending along a direction of the resonator and having a cross-section that is substantially circular, elliptical or substantially quadratic.

29. Laser-active medium according to claim 28, wherein the laser-active medium is rod-shaped, or plate-shaped.

30. Laser-active medium according to claim 28, wherein the pumped light source comprises a plurality of laser diodes.

31. Method for pumping a solid state laser or slab laser provided with a laser-active medium (slab), a highly reflecting layer on one side of the laser-active medium, a resonator defined by at least partially reflecting surfaces, and a pumped light source, comprising the steps of:
generating pumped light with the pumped light source;
coupling the pumped light into the laser-active medium through a first entry site on the laser-active medium, and reflecting pumped light that has performed a first passage through the laser-active medium with the highly reflecting layer to perform a second passage through the laser-active medium; and
using a first added reflector to reflect pumped light that has performed the second passage through the laser-active medium back into the laser-active medium through a second entry site on the laser-active medium to perform a third passage through the laser-active medium, the second entry site being displaced at least partially with respect to the first entry site along a direction of an axis of the resonator.

32. Method according to claim 31, comprising the further steps of:
reflecting pumped light that has performed the third passage through the laser-active medium back through the laser-active medium with the highly reflecting layer to perform a fourth passage through the laser-active medium; and
using a second added reflector to reflect pumped light that has preformed the fourth passage through the laser-active medium back along a same path through the laser-active medium.

33. Method according to claim 31, wherein the pumped light is generated by means of laser diodes.
